(19) United States
(12) Patent Application Publication
(10) Pub. No.: US 2025/0244554 A1
(43) Pub. Date: Jul. 31, 2025

(54) SMARTPHONE CAMERA FILTERS

(71) Applicant: Daniel John Dobi, Hawthorne, CA (US)

(72) Inventor: Daniel John Dobi, Hawthorne, CA (US)

(21) Appl. No.: 18/644,674

(22) Filed: Apr. 24, 2024

Related U.S. Application Data
(60) Provisional application No. 63/627,315, filed on Jan. 31, 2024.

(51) Int. Cl. G02B 7/00; G03B 11/00; H04M 1/02

(52) U.S. Cl. CPC G02B 7/006; G03B 11/00; H04M 1/0264; H04M 2250/52

(57) ABSTRACT

A device and method for interchangeably mounting camera filters to a camera module of a smartphone. The device includes a base plate; an aperture in the base plate, wherein the aperture corresponds to a camera module of the smartphone; and a skirt that extends perpendicularly from a periphery of the base plate, wherein an inner surface of the skirt has threads for mounting the camera filter.

### CROSS-REFERENCE TO RELATED APPLICATIONS

This application claims priority from a U.S. Provisional Patent Appl. Ser. No. 63/627,315, filed on Jan. 31, 2024, which is incorporated herein by reference in its entirety.

### FIELD OF INVENTION

The present invention relates to smartphone camera filters, and more particularly, the present invention relates to smartphone camera filters that can be interchangeably used.

### BACKGROUND

The use of camera filters among photographers is quite common. Camera filters are used for a variety of reasons. In particular, the camera filters manipulate lighting conditions for a variety of effects, such as reducing the intensity of light, minimizing reflections, and/or glares. Multiple filters are interchangeably used for different lighting effects or lighting condition manipulations.

Nowadays, smartphones are also getting equipped with some great camera modules. Smartphones are being used for photography more than actual cameras. To enhance the photographic experience using smartphones, camera filters adapted for use with smartphone cameras are becoming popular.

However, the present camera filters for smartphones have limited utility for a variety of reasons and are also expensive. A need is therefore appreciated for improvements in camera filters for smartphones.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The present invention relates to a device for interchangeably using camera filters with a smartphone.

Another object of the present invention is that the device allows the use of pre-existing filters.

Still another object of the present invention is that the device makes the use of multiple filters economical.

Yet another object of the present invention is to enhance their photography experiences.

A further object of the present invention is that the device is light in weight.

In one aspect, disclosed is a device for use with a smartphone for interchangeably mounting camera filters, the device comprising a base plate; an aperture in the base plate, wherein the aperture corresponds to a camera module of the smartphone; and a skirt extends perpendicularly from a periphery of the base plate, wherein an inner surface of the skirt has threads for mounting the camera filters. The base plate and the skirt form a filter member of the device, wherein the device further comprises a ring member, wherein the ring member is pivotally coupled to the ring member. At least the base plate is made of ferromagnetic material.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a perspective view of a camera filter device for a smartphone, according to an exemplary embodiment of the present invention.

FIG. 2 shows another embodiment of the camera filter device for a smartphone, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is a camera filter device for smartphones that allows for interchangeability using camera filters. The disclosed device can fit over the camera lens and is supported on the phone body. The disclosed device can be used for smartphones that have magnetic mechanisms on the rear sides of the body. For example, iPhone® by Apple® includes magnets for quickly attaching accessories through magnetic forces, known as MagSafe®. The disclosed device can magnetically attach to the rear side of the smartphone.

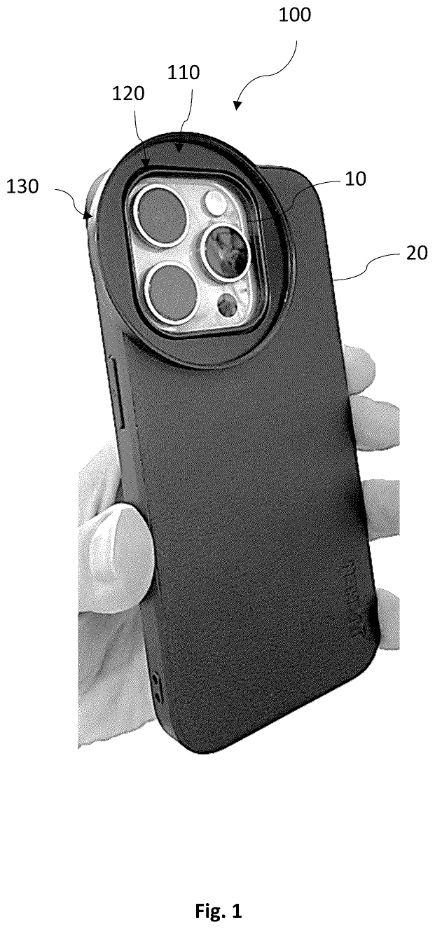

Referring to FIG. 1 which shows the device 100 mounted to a camera module 10 of a smartphone 20. Device 100 includes a base plate 110 having an aperture 120. The shape of the aperture corresponds to the camera module. A smartphone can have more than one camera in a camera module, as shown in the drawing. Typically, the aperture can fit around the protruding body of the housing of the camera module of the smartphone. It is to be noted that the camera body of the smartphone may not be protruding outwards, and in such a case the aperture can lie around the housing of the camera body. It may be important that the base plate does not cover or shadow the camera lenses.

A cylindrical skirt 130 extends perpendicular from a periphery of the base plate. The inner surface of the skirt has threads for coupling the camera filters. A camera filter having coupling threads can be mounted to the device. For interchangeably coupling camera filters of different sizes, step-up rings can be used. Step-up rings may allow using existing camera filters with the disclosed device, thus making the process economical and versatile.

In certain implementations, the disclosed device can be made a part of a cover of the smartphone that can be applied to the rear side of the smartphone. The cover may or may not use magnetic forces to attach to the smartphone. In certain implementations, the cover can be a full-body cover.

The device or at least the base plate of device 100 can be made from ferromagnetic material. The skirt and the base plate can be integrally formed from the same material.

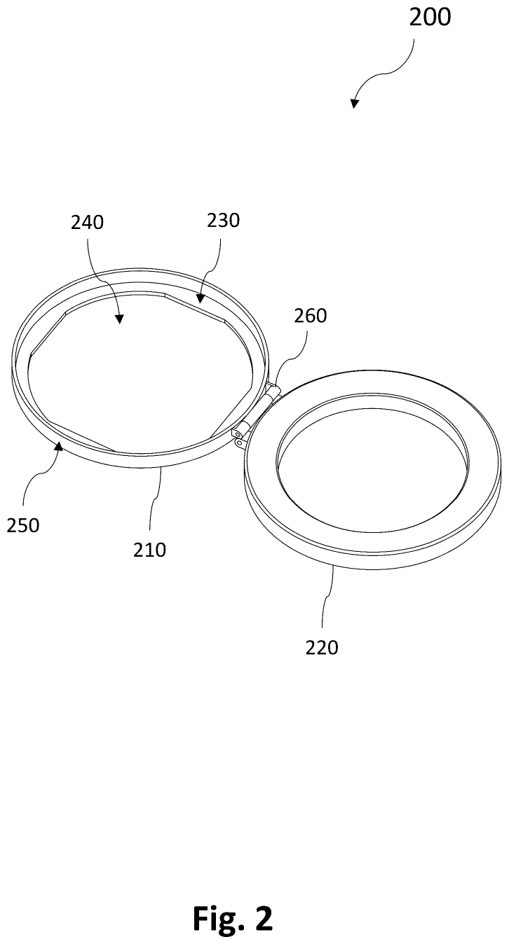

Referring to FIG. 2 which shows another embodiment of a device 200 that includes a filter member 210 and a ring member 220. The filter member can be similar to device 100. The filter member 210 includes a base plate 230 having an aperture 240. The shape of the aperture can correspond to the shape of the camera module. A smartphone can have more than one camera in a camera module, as shown in the drawing. Typically, the aperture can fit around the protruding body of the housing of the camera module of the smartphone. It is to be noted that the camera body of the smartphone may not be protruding outwards, and in such a case the aperture can lie around the housing of the camera body. It may be important that the base plate does not cover or shadow the camera lenses.

A cylindrical skirt 250 extends perpendicular from a periphery of the base plate. The inner surface of the skirt has threads for coupling the camera filters. A camera filter having coupling threads can be mounted to the device. For interchangeably coupling camera filters of different sizes, step-up rings can be used. Step-up rings may allow using existing camera filters with the disclosed device, thus making the process economical and versatile.

The ring member can be pivotally coupled to the filter member using a hinge joint 260. The hinge joint allows the folding of the filter member over the ring member. At least the ring member can be made from ferromagnetic material for magnetically attaching to the rear side of the smartphone. The device 200 can be magnetically mounted through the ring member and the filter can be put around the camera module. The device 200 can also be used as a pivot stand for the smartphone.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A device for use with a smartphone for interchangeably mounting camera filters, the device comprising:
a base plate;
an aperture in the base plate, wherein the aperture corresponds to a camera module of the smartphone; and
a skirt extends perpendicularly from a periphery of the base plate, wherein an inner surface of the skirt has threads for mounting the camera filters.

2. The device of claim 1, wherein the base plate and the skirt forms a filter member of the device, wherein the device further comprises a ring member, wherein the ring member is pivotally coupled to the ring member.

3. The device of claim 1, wherein at least the base plate is made of ferromagnetic material.

4. A method for interchangeably mounting camera filters to a camera module of a smartphone, the method comprising:
providing a device comprising:
a base plate;
an aperture in the base plate, wherein the aperture corresponds to a camera module of the smartphone; and
a skirt extends perpendicularly from a periphery of the base plate, wherein an inner surface of the skirt has threads for interchangeably mounting the camera filters; and
coupling a camera filter with threads to the device.

5. The method of claim 4, wherein the base plate and the skirt forms a filter member of the device, wherein the device further comprises a ring member, wherein the ring member is pivotally coupled to the ring member.

6. The method of claim 4, wherein at least the base plate is made of ferromagnetic material.
